(19) United States
(12) Patent Application Publication
(10) Pub. No.: US 2025/0143330 A1
(43) Pub. Date: May 8, 2025

(54) APPARATUS AND METHOD FOR PASTEURIZING EGGS

(71) Applicant: Gerd BERGMEIER, Hiddenhausen (DE)

(72) Inventor: Gerd BERGMEIER, Hiddenhausen (DE)

(21) Appl. No.: 18/684,359

(22) PCT Filed: Aug. 18, 2022
(86) PCT No.: PCT/EP2022/073039

§ 371 Date: Feb. 16, 2024

(30) Foreign Application Priority Data
Aug. 20, 2021 (DE) 10 2021 121 697.4

(51) Int. Cl. A23B 5/005; A23B 5/06

(52) U.S. Cl. CPC A23B 5/0052; A23B 5/065

(57) ABSTRACT

An apparatus for pasteurizing eggs includes a feeder for receiving and transferring eggs to a carrier, a chamber for heating and pasteurizing the eggs, a conveyor for moving the carrier with the eggs through the chamber, a transfer station for transferring the eggs from the carrier to a transport device, and a packing station for packing the coated eggs. A spraying device sprays liquid on the eggs in the chamber can be sprayed with a liquid to pasteurize the eggs.

### BACKGROUND AND SUMMARY OF THE INVENTION

Exemplary embodiments of the present invention relate to an apparatus for pasteurizing eggs comprising a feeder for receiving and transferring eggs to a carrier, a chamber for heating and pasteurizing the eggs, a conveyor for moving the carrier with the eggs through the chamber, a transfer station for transferring the eggs from the carrier to a transport device, and a packing station for packing the coated eggs. The invention further relates to a method of pasteurizing comprising the following steps: feeding eggs to a feeding station for receiving and transferring eggs to a carrier, moving the carrier with the eggs through a chamber and heating the eggs for pasteurization, transferring the eggs from the carrier to a transport device, coating the eggs at a coating device, and packing the coated eggs.

US 2011/0300023 A1 discloses a device and a method for pasteurizing eggs, in which the eggs are filled into carriers in several layers. These carriers with the stacked eggs are placed in a cold state in a bath of hot water and then passed through to heat the eggs to a predetermined temperature and thereby kill salmonella in the eggs. After the carriers have been drawn through the bath, they are removed with the eggs and processed further, for example coated and packaged. The disadvantage of this process is that the energy required to heat and circulate the water bath is comparatively high and the temperature control in the water bath is complex. In addition, the eggs are rigidly arranged in the carriers so that the yolk can move upwards during pasteurization, which has a detrimental effect on the appearance of cooked eggs.

Accordingly, exemplary embodiments of the present invention are directed to a device and a method for pasteurizing eggs that can be operated with low energy input and avoid the above disadvantages.

In the device according to the invention, a spraying device is provided in the chamber for heating and pasteurizing the eggs, by means of which the eggs in the chamber can be sprayed with a liquid. As a result, the eggs no longer have to be passed through a water bath via carriers, but can be pasteurized via the sprayed heated or warmed liquid, in particular water. The sprayed liquid can be easily tempered, which reduces the amount of control required to set the temperature in the chamber. The chamber can be divided into different zones in order to first heat and then pasteurize the eggs, whereby the temperature and/or the amount of liquid sprayed out can be constant or different. This process is also effective and can be carried out with low energy consumption, especially if the walls around the interior of the chamber are suitably insulated.

Preferably, the eggs can be rotated at least in sections via the carriers during movement through the chamber. For this purpose, the carriers can be guided in a meandering manner via the conveyor device, whereby the eggs can be rotated together with the carrier at least at the deflections of the conveyor device. The carriers can be moved upwards and downwards along the vertical sections, for example, whereby the spraying device is arranged between two vertical sections for a compact design, so that the liquid can be sprayed on both sides in order to wet the carriers and the eggs arranged therein.

Preferably, each carrier is channel-shaped with a large number of receptacles for the eggs. Each receptacle can be designed as an opening so that the eggs can be wetted with liquid from different sides. Due to the channel-shaped design of the carriers, the eggs can initially rest on one leg of the carrier when passing through the chamber and then be rolled from this leg onto the other leg when the carrier passes through a deflection of a meandering guide path. This rotational movement of the eggs during pasteurization prevents the yolk from moving upwards during pasteurization, so that the yolk remains in the center of the egg even after pasteurization.

For efficient use of the liquid, it is preferably circulated via a pump, whereby the liquid sprayed and collected from the chamber can be fed back to the spraying device via the pump. This also reduces the energy required to heat the liquid.

An inspection station with a scanner is preferably provided behind the chamber, which can be used to detect cracks in the surface structure of the eggs. This makes it easy to sort out faulty eggs. The inspection station is preferably located upstream of a coating station for coating the eggs so that smaller, remaining cracks can then be sealed via the coating station. A cooling station is preferably provided behind the coating station, by means of which the coated eggs can be cooled in order to preserve them for as long as possible.

In the process according to the invention, the eggs are picked up at a feed station and preferably transferred to a carrier via a roller conveyor at a transfer point. The carrier with the eggs is then moved through a chamber for heating and pasteurizing the eggs, in particular in a meandering manner. The eggs are then transferred from the carrier to a transport device for optional coating and packaging. The eggs are sprayed with a liquid in the chamber for heating and pasteurization in order to expose them to a predetermined temperature, for example between 55 and 65° C., in order to kill salmonella by heating the eggs. This process can be carried out in a particularly energy-efficient manner by spraying with liquid, especially hot water.

During the process through the chamber, the eggs are preferably rotated over at least part of the path so that the yolk remains in the center of the eggs. For this purpose, the eggs can be moved via the carriers along a meandering path, whereby the eggs are rotated at least at the deflections of the meandering path. The carriers for the eggs can be moved around inside the chamber via the conveyor system so that they do not have to be heated each time new eggs are picked up. The carriers can pick up eggs to be pasteurized at an inlet of the chamber and then discharge the pasteurized eggs at an outlet of the chamber. This increases energy efficiency if the carriers are circulated in the chamber and do not leave the chamber, so that they can be kept at a constant temperature level in the chamber.

Preferably, the dwell time of the eggs in the chamber is between 20 min and 60 min, depending on how high the log level is selected for reducing the salmonella load. A dwell time in the chamber of between 30 min and 50 min has proven to be particularly advantageous.

The liquid used for spraying the eggs is preferably collected in a collecting basin in the chamber and circulated in a circulation process. The collected liquid can then be purified using a filter and optionally a UV station, in which the liquid is sterilized using UV light. This simplifies the tempering of the liquid to the desired temperature.

An inspection station for detecting cracks in the surface structure is preferably provided behind the chamber, whereby the eggs are scanned and rotated over the transport device during scanning so that defective eggs can be easily sorted out.

The device for pasteurizing eggs enables the eggs to be transported in a continuous process so that each egg can be traced exactly. It is possible to identify which egg from which batch is arranged in a predetermined package, as the conveying and transport devices are preferably designed in such a way that the eggs are guided without contact to other eggs and each egg can be assigned a predetermined position by a control system.

### BRIEF DESCRIPTION OF THE DRAWING FIGURES

The invention is explained in more detail below with reference to the accompanying drawings. It shows:

FIG. 1A a side view of a device for pasteurizing eggs according to the invention;

FIG. 1B a top view of the device shown in FIG. 1;

FIG. 2 is a schematic view of the chamber conveyor, and

FIG. 3 a detailed view of an egg in the coating station.

### DETAILED DESCRIPTION

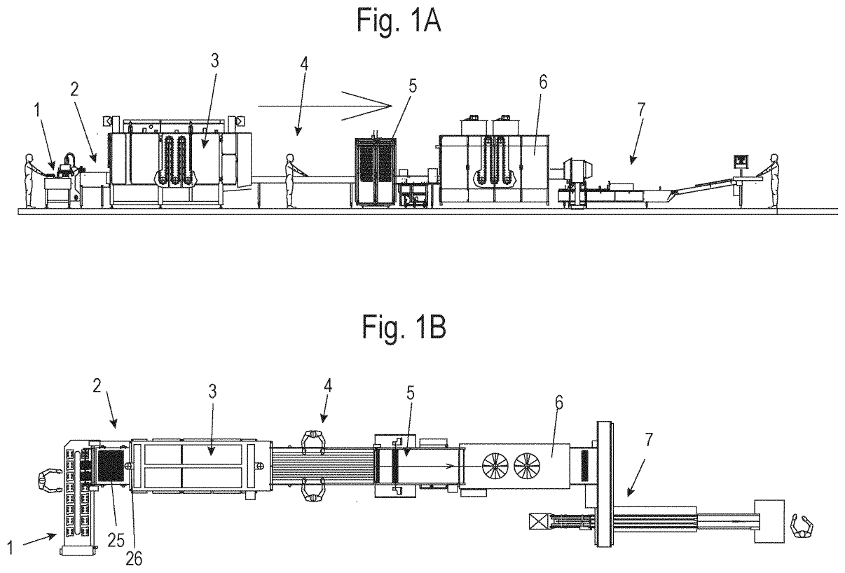

FIGS. 1A and 1B show a device for pasteurizing eggs, which has a loading station 1 at the beginning, at which the eggs are fed via carriers. The eggs can then be transferred from the loading station 1 to a feeding device 2, which removes the eggs from the carriers, for example via suction devices. The eggs can then be transported and separated via a roller conveyor 25, with each egg resting on two rollers which are moved in the direction of transportation and additionally rotated so that the eggs are aligned with their longitudinal axis parallel to the longitudinal axis of the rollers. This roller conveyor 26 can then transfer the eggs at a transfer point 26 to a carrier, which guides the eggs through a chamber 3 for heating and pasteurization.

From chamber 3, the pasteurized eggs are each transferred from a carrier to a transport device in order to detect cracks in the surface structure at an inspection station 4 and to be able to sort out defective eggs. After inspection station 4, the eggs are fed to a coating station 5 before being cooled down in a cooling station 6.

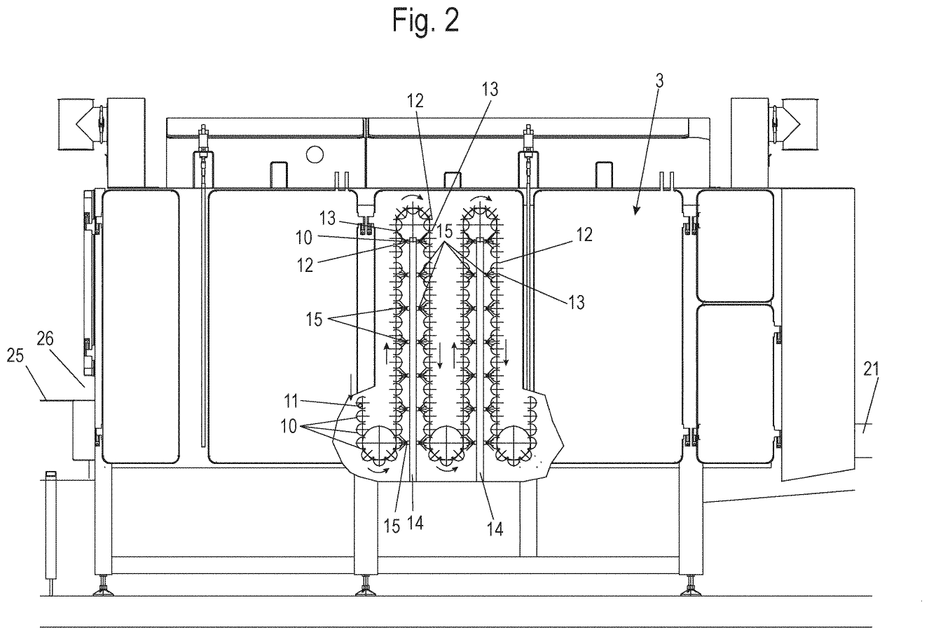

FIG. 2 shows chamber 3 for pasteurization. The eggs to be pasteurized come from the roller conveyor 25, through which several parallel tracks of eggs are conveyed to chamber 3. Each egg rests between two rollers, which rotate and move towards chamber 3 so that a row of eggs can be transferred to a carrier 10 at a transfer point 26, which is guided in a circulating manner over a conveyor device in chamber 3. The carrier 10 can be designed as disclosed in patent EP 3 087 017 B1, to which reference is hereby made. The carrier 10 is channel-shaped and has numerous receptacles in the form of openings into each of which an egg can be inserted. Depending on the length of the carrier, for example 5-30 eggs, in particular 8-18 eggs, can be inserted into one carrier.

A part of the conveyor system in chamber 3 is shown schematically in the central area of FIG. 2. The carriers 10 are channel-shaped and U-shaped in cross-section and comprise a rear leg 12 and a front leg 13 in the conveying direction. In FIG. 2, only one egg 11 is shown on the carrier 10, wherein a plurality of eggs 11 are arranged one behind the other in the longitudinal direction of the carrier 10, and moreover all carriers can be filled with one or more eggs 11. The carriers 10 are guided over the conveyor device in a meandering manner, with the carriers 10 being moved upwards and downwards in vertical sections. There is a deflection between two vertical sections, which is schematically indicated by the curved arrow. It can be seen that the support 10 rotates by approximately 180° at a deflection, so that the trailing leg 12 is initially positioned at the bottom and then positioned at the top after the deflection. Due to the rotary movement of the carrier 10 in the area of the deflection, the eggs 11 arranged in the carrier 10 also rotate, so that upward floating of the egg yolk is prevented by a stationary alignment and a long dwell time in the chamber 3. The carrier 10 and the egg 11 are rotated in opposite directions at the deflection points. The rotation of the carriers 10 and the eggs 11 takes place both at the upper deflection points and at the lower deflection points.

The eggs 11 are to be heated to a predetermined temperature for pasteurization, for example between 55 and 65° C., whereby the eggs 11 are sprayed with a liquid for this purpose, in particular hot water. Optionally, additives can also be added to the hot water. A spraying device 15 with a plurality of nozzles is arranged adjacent to the carriers 10, wherein the nozzles spray the warm or hot liquid onto the eggs 11, which are arranged in the carriers 10. The spraying device 15 comprises nozzles which are arranged between two vertical sections of the conveyor device, so that the nozzles can spray the warm or hot liquid on both sides. The spraying device 15 with the nozzles is supplied via lines 14.

FIG. 2 only shows a small section of the conveyor system that runs through chamber 3. The carriers 10 are circulated within chamber 3 and therefore do not reach the environment, which would require reheating. The eggs 11 taken over by the feeding device 2 can first be preheated in chamber 3, for example by air and mist inside chamber 3. After a preheating time, the eggs 11 in the carriers 10 are sprayed with liquid, preferably at a temperature of between 58° C. and 62° C. The sprayed water is then applied to the carriers 10. The sprayed water is then collected in a collecting basin and directed to a sump. From there, the collected water can be conveyed via a pump to a line that is connected to the lines 14 so that the warm water can be sprayed onto the eggs 11 again. Upstream or downstream of the pump, devices for cleaning the liquid can be provided, in particular a filter and a UV cleaning station, in which the liquid is irradiated with UV light in order to sterilize the liquid. The cleaned liquid can then circulate.

After the eggs 11 have been in the chamber 3 for between 30 minutes and 60 minutes, in particular 40 minutes to 50 minutes, the eggs are transferred from the carriers 10 to a transport device 21. The transport device 21 can be designed as a roller conveyor in which the eggs rest on two roller bars that move in the transport direction and also rotate. The transport device 21 guides the eggs 11 through the inspection station 4, which can include a scanner, whereby the eggs 11 are rotated during scanning via the transport device 21 in order to detect any cracks in the surface structure. Defective eggs can thus be easily sorted out after the inspection station 4, optionally also via an automatic removal device. Additionally, or alternatively, a manual quality control of the surface structure of the eggs 11 can also be carried out.

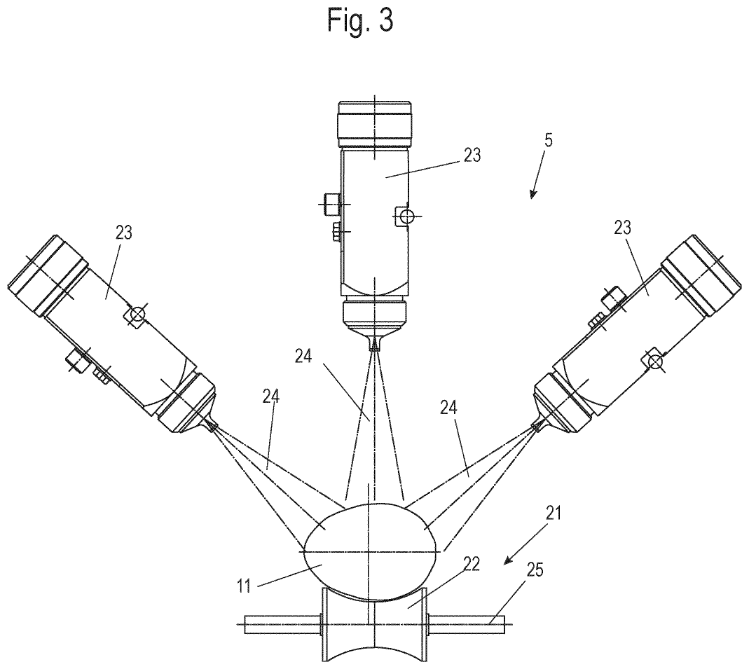

Behind the inspection station 4, the eggs 11 are transported via the transport device 21 to a coating station 5, which is shown in detail in FIG. 3. Each egg 11 rests on two adjacent supports 22, which are curved and adapted to the outer contour of the eggs 11. Each support 22 is arranged on a rotating rod 27, which moves in the transport direction, so that the egg 11 also rotates during the transport movement.

One or more spray nozzles 23 are arranged around the egg 11, which spray a coating liquid 24 onto the egg 11. Optionally, the supports 22 of the transport device can be star-shaped in cross-section and have a large number of outwardly projecting prongs so that there is only a small contact surface between the egg and the support 22. The eggs 11 can thus be coated in a continuous process, whereby shellac, a wax or another coating material approved for foodstuffs can be used for coating.

The coated eggs are now fed via the transport device to the cooling station 6, which is shown in FIGS. 1A and 1B. The transport device transfers the eggs to individual transport elements, which are moved through the cooling chamber in a meandering manner, at least in certain areas. The transport elements are guided around the cooling station 6 in order to minimize heat transfer from the outside into the cooling chamber.

A packing station 7 is provided downstream of the cooling station 6, where the coated and cooled eggs can be transferred to the desired packaging container, in particular an egg carton. The egg cartons can be labeled accordingly, whereby the separation of the eggs at the start of the process makes it possible to track which egg it is, i.e., which batch it comes from.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SYMBOLS

1 Charging station
2 Feeding device
3 Chamber
4 Test station
5 Coating station
6 Cooling station
7 Packing station
10 Carrier
11 Egg
12 Thigh
13 Thigh
14 Line
15 Spray device
21 Transport equipment
22 Transport equipment
23 Spray nozzle
24 Coating liquid
25 Roller conveyor
26 Transfer
27 Rod

1-15. (canceled)

16. An apparatus for pasteurizing eggs, the apparatus comprising:
a feeding device configured to receive and transfer eggs to a carrier;
a chamber configured to heat and pasteurize the eggs using, at least, a spraying device configured to spray a liquid on the eggs in the chamber;
a conveyor device configured to the carrier with the eggs through the chamber;
a transfer station configured to transfer the eggs from the carrier to a transport device, and
a packing station configured to pack the eggs.

17. The apparatus of claim 16, wherein the eggs are rotatable at least in sections via the carrier during a movement through the chamber.

18. The apparatus of claim 16, wherein the carrier is guided over the conveying device in a meandering manner and the eggs are rotatable together with the carrier at least at one deflection of the conveying device.

19. The apparatus of claim 18, wherein the carrier is movable upwards and downwards along vertical sections and the spraying device is arranged between two of the vertical sections.

20. The apparatus of claim 16, wherein the carrier is channel-shaped with a plurality of receptacles for eggs.

21. The apparatus of claim 16, further comprising:
a pump configured to feed collected liquid from the chamber back to the spraying device.

22. The apparatus of claim 16, further comprising:
an inspection station with a scanner configured to detect cracks in a surface structure of the eggs.

23. The apparatus of claim 16, further comprising:
a coating station configured to coat the eggs; and
a cooling station configured to cool the coated eggs.

24. A method for pasteurizing eggs, the method comprising:
feeding eggs to a feeding station that receives and transfer the eggs to a carrier;
moving the carrier with the eggs through a chamber and heating the eggs for pasteurization in the chamber by, at least, spraying the eggs with a liquid to heat the eggs for pasteurization;
transferring the eggs from the carrier to a transport device; and
packing the eggs transferred to the transport device.

25. The method of claim 24, wherein the eggs are rotated at least over part of a path when moving through the chamber.

26. The method of claim 24, wherein the eggs are moved over the carrier along a meandering path and the eggs are rotated at the deflections of the meandering path.

27. The method of claim 24, wherein a dwell time of the eggs in the chamber is between 20 min and 60 min.

28. The method of claim 24, wherein the liquid for spraying the eggs is collected and circulated in a circulation process.

29. The method of claim 28, wherein the collected liquid is purified via a filter and a UV station.

30. The method of claim 24, further comprising:
scanning the eggs in an inspection station to detect cracks in a surface structure of the eggs, wherein the eggs are rotated via the transport device during scanning.
